(19) United States
(12) Patent Application Publication
(10) Pub. No.: US 2006/0053363 A1
(43) Pub. Date: Mar. 9, 2006

(54) Graphically defining a formula for use within a spreadsheet program

(76) Inventors: Christopher Ian Bargh, Scarborough (AU); Gregory Owen Johnston, Bicton Wa (AU); Russell Benedict Jones, Subiaco Wa (AU)

Correspondence Address: KNOBBE MARTENS OLSON & BEAR LLP, 2040 MAIN STREET, FOURTEENTH FLOOR, IRVINE, CA, 92614, US

(21) Appl. No.: 11/213,337

(22) Filed: Aug. 26, 2005

Related U.S. Application Data
(63) Continuation of application No. PCT/AU04/00262, filed on Feb. 27, 2004.

(30) Foreign Application Priority Data
Feb. 28, 2003 (AU) 2003900913

(51) Int. Cl. G06F 17/24

(52) U.S. Cl. 715/503; 715/538

(57) ABSTRACT

A graphically defined formula is used within a spreadsheet implemented by a spreadsheet computer program by placing a reference to the graphically defined formula created by a tool. The reference is used to interface the spreadsheet computer program to an engine for evaluating the graphically defined formula. The graphically defined formula is evaluated by the engine by passing input data from the spreadsheet to the engine to produce a result by evaluating the graphically defined formula using the input data and passing the result from the engine to the spreadsheet computer program for entry into the spreadsheet.

### RELATED APPLICATIONS

This application is a continuation application, and claims the benefit under 35 U.S.C. §§ 120 and 365 of PCT Application No. PCT/AU2004/000262, filed on Feb. 27, 2004 and published on Sep. 10, 2004, in English, which is hereby incorporated by reference.

### BACKGROUND OF INVENTION

1. Field of Invention

The present invention relates to spreadsheet computer programs and a method for graphically defining a formula within a spreadsheet program. It also relates to a method of using a graphically defined formula within a spreadsheet program.

2. Description of Related Technology

Spreadsheets are in common use to perform calculations and model processes. A well known spreadsheet program is Microsoft Excel, which runs on a number of platforms including the Windows platform and the Macintosh platform.

A spreadsheet includes a grid of cells. Cells, are referenced by a letter for the column the cell is within and a number for the row the cell is within, in a similar manner to a reference to a location on a map. A cell can contain a value or a function. In the case of a function the result of the function is displayed in that cell. The function references other cells which form the arguments of the function.

Spreadsheets are inherently text based, ie numbers and letters are displayed. Graphics can be provided in a spreadsheet, but they are static and are not involved in the processing of the model represented by the spreadsheet. A graphic often displayed is a graph or chart based on numbers in referenced cells.

Embodiments of the present invention seek to provide the ability to graphically define a model or formula in a spreadsheet program and/or the ability to use a graphically defined formula in a spreadsheet program. The functionality to graphically build or define a model or formula in a spreadsheet program is currently not provided.

It is to be understood that, if any prior art publication is referred to herein, such reference does not constitute an admission that the publication forms a part of the common general knowledge in the art, in Australia or any other country.

### SUMMARY OF CERTAIN INVENTIVE ASPECTS

According to a first aspect of the present invention there is provided a method of using a graphically defined formula within a spreadsheet computer program, comprising the following: providing a spreadsheet computer program that implements a spreadsheet; providing an engine for evaluating a graphically defined formula; and interfacing the spreadsheet computer program to the engine comprising: passing input data from the spreadsheet to the engine to produce a result by evaluating the graphically defined formula using the input data; and passing the result from the engine to the spreadsheet computer program for entry into the spreadsheet.

Preferably the step of interfacing the engine to the spreadsheet computer program is conducted by providing an interface function in a cell of the spreadsheet, with arguments of the function comprising cells in the spreadsheet containing the input data to be passed to the engine, and the result from the engine being provided in the cell in which the interface function is provided.

Preferably the interface function comprises a reference to the graphically defined formula as another argument to the function.

Preferably the interface function is in the form of a component of an add-in to the spreadsheet computer program.

Preferably the graphically defined formula can be selected from one or more provided graphically defined formulae. Alternatively, the graphically defined formula may be an existing graphically defined formula that is altered using the tool for graphically defining a formula. Alternatively, the graphically defined formula is defined by interfacing the spreadsheet program to the tool for graphically defining the formula, using the tool to graphically define the formula, saving a definition of the graphically defined formula and passing a reference to the graphically defined formula to the spreadsheet computer program.

Preferably the graphically defined formula is graphically displayed. Preferably the graphically defined formula may be displayed by the tool for graphically defining the formula. Alternatively, the graphically defined formula may be displayed on the spreadsheet.

According to a second aspect of the present invention there is provided a method of graphically defining a formula for use within a spreadsheet computer program, comprising the following: providing a spreadsheet computer program that implements a spreadsheet; providing a computer implemented tool for graphically defining a formula; graphically defining a formula using the tool; and placing a reference to the graphically defined formula in the spreadsheet, where the reference is used to interface the spreadsheet computer program to an engine for evaluating the graphically defined formula, preferably by: passing input data from the spreadsheet to the engine to produce a result by evaluating the graphically defined formula using the input data; and passing the result from the engine to the spreadsheet computer program for entry into the spreadsheet.

Preferably the tool is activated by the spreadsheet computer program calling the tool.

Preferably the reference to the graphically defined formula is placed in one or more cells in which the result(s) of evaluation of the graphically defined formula are to be displayed.

Preferably input data to the graphically defined formula is selected by placing a reference to cells containing the input data in the cell(s) containing the reference to the graphically defined formula.

Preferably the reference to the graphically defined formula and the reference to the input data cells form arguments to an interface function placed in the spreadsheet.

Preferably the interface function is in the form of a component of an add-in to the spreadsheet computer program.

Preferably the add-in comprises a calling routine for calling the tool.

According to a third aspect of the present invention there is provided a computer program for controlling a computer to perform either of the abovementioned methods.

According to a fourth aspect of the present invention there is provided a computer readable medium for storing a computer program as defined above.

According to a fifth aspect of the present invention there is provided a system for using a graphically defined formula within a spreadsheet computer program comprising: spreadsheet means for providing a spreadsheet; an engine for evaluating a graphically defined formula; and an interface for: passing input data from the spreadsheet to the engine means to produce a result by evaluating the graphically defined formula using the input data; and passing the result from the engine means to the spreadsheet means for entry into the spreadsheet.

According to a sixth aspect of the present invention there is provided a system for graphically defining a formula for use within a spreadsheet comprising: spreadsheet means for providing a spreadsheet; a tool for graphically defining a formula; and a reference indicator for placing a reference to the graphically defined formula in the spreadsheet, where the reference is used to interface the spreadsheet means to an engine for evaluating the graphically defined formula.

According to a seventh aspect of the present invention there is provided an add-in to a spreadsheet computer program, comprising: an interface between the spreadsheet computer program and a tool for graphically defining a formula, wherein the interface activates the tool to graphically define the formula and wherein the interface places a reference to the graphically defined formula into the spreadsheet.

Preferably the interface passes the reference to the graphically defined formula to an engine for evaluating the graphically defined formula to identify the graphically defined formula to be evaluated.

According to a eighth aspect of the present invention there is provided an add-in for a spreadsheet computer program, comprising: an interface between the spreadsheet computer program and an engine for evaluating a graphically defined formula wherein the interface passes input data to the engine to produce a result based on the input data according to the graphically defined formula, and wherein the interface passes the result to the spreadsheet computer program for use in the spreadsheet.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

### BRIEF DESCRIPTION OF THE DRAWINGS

In order to provide a better understanding, embodiments of the present invention will be described in greater detail, by way of example only, with reference to the accompanying drawings, in which:

FIG. 1 is an example of a spreadsheet showing a function that provides an interface point to a graphically defined formula for use in the spreadsheet;

FIG. 2 is an example of a spreadsheet with a plurality of input values inputting into a function that provides an interface point to a graphically defined formula that provides its result to a cell of the spreadsheet; and

FIG. 3 shows the spreadsheet of FIG. 2 overlayed with a tool for graphically defining a formula displaying the graphically defined formula.

### DETAILED DESCRIPTION OF CERTAIN INVENTIVE EMBODIMENTS

There are many commercially available spreadsheet computer programs including Microsoft Excel, Lotus 1-2-3, Star Office Spreadsheet and the like. The examples hereafter use Microsoft Excel as it is probably the most widely used spreadsheet program. The present invention is equally applicable to other spreadsheet programs.

When referring to a graphically defined formula, it is intended to mean “a formula represented graphically where one or more input variables are manipulated by one or more operator components to produce one or more result variables”. A method of graphically defining a formula is described in the specification accompanying International Application No. PCT/AU01/01053 published under Number WO 02/17074. The contents of this specification are incorporated herein by reference.

It is also noted that the formula can be representative of a model rather than a strictly mathematical formula per se. Accordingly, the term “formula” is intended to include the concept of a model.

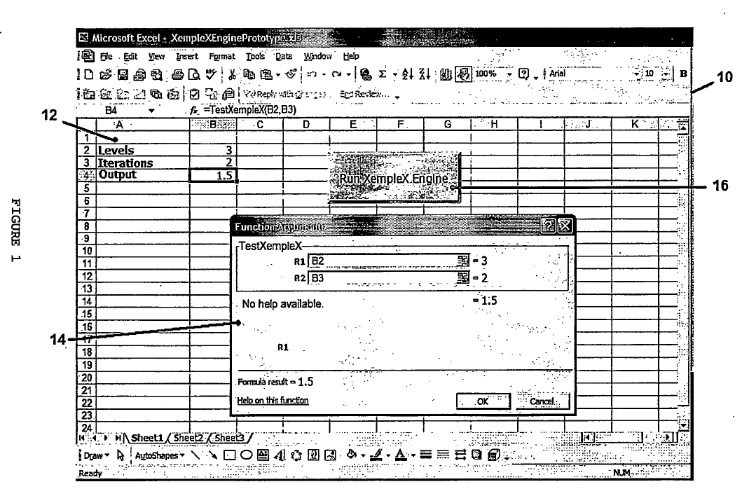

Referring to FIG. 1, a screen shot of a window 10 of a spreadsheet implemented by a spreadsheet computer program is shown. The spreadsheet includes a plurality of cells 12 indexed by column (letters) and row (numerals) labels. The cell in B4 is highlighted. This cell is identified in the usual manner with a column reference first and then a row reference in a similar manner to identifying a location on a map. Cell B4 contains a function called TestXemplex having the arguments B2, B3. TestXemplex is a registered function that takes the arguments, that is the values in the cells B2 and B3, and manipulates them to produce a result in the cell B4 according to the TestXemplex formula. This can be seen in the Function Arguments window 14 that overlays the lower portion of cells in the spreadsheet.

In this instance, the TestXemplex formula forms part of an add-in for the spreadsheet that causes an interface to be initiated between the spreadsheet computer program and a run time engine. The interface passes the values in the function arguments to the run time engine to calculate a result of the TestXemplex function. The interface also provides the result of the TestXemplex function as evaluated by the engine back to the spreadsheet computer program for displaying the formula result in cell B4 of the spreadsheet. TestXemplex could be any suitable function or model. The result of the TestXemplex function is determined by a graphically defined formula created by a graphical formula creation tool. The tool for graphically defining a formula may be that described in International Patent Application No. PCT/AU01/01053. The graphically defined formula has a graphical definition and a logical definition. The graphical definition defines the display of the formula. The logical definition defines the manner of evaluation of the formula by the engine. The run time engine interprets the logical definition of the graphically defined formula to manipulate input data according to the definition to produce the result data.

The TestXemplex function acts as a reference to the graphically defined formula. In this case TestXemplex receives two inputs (the function arguments “Levels” and “Iterations”), performs a calculation on the values in the arguments and returns a result “Output”.

This process provides superior functionality to the spreadsheet alone. It allows a formula to be graphically defined using the graphical formula definition tool so that a conceptual model or formula is more easily defined and that formula can then be used in a conventional work environment such as a spreadsheet. As a result, the graphically defined formula becomes accessible from within the spreadsheet.

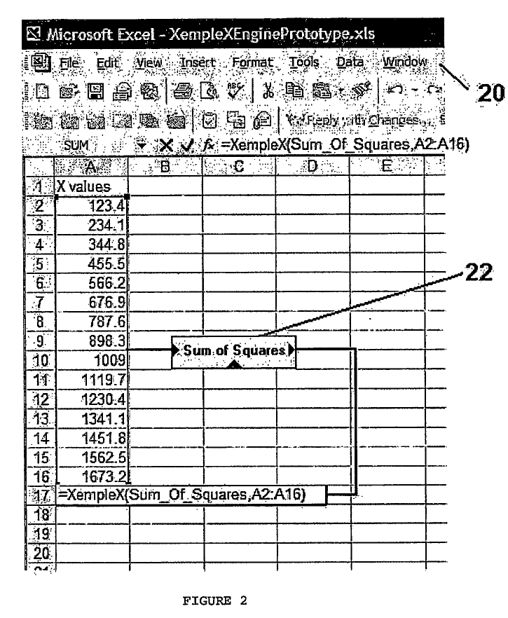

Referring to FIG. 2, another screen shot 20 of a spreadsheet implemented by a spreadsheet computer program is shown with a series of “X values” in column A at rows 2-16 (A2:A16) and a function in cell A17. In this case, the function is called Xemplex and includes the arguments “Sum_Of_Squares”, and A2:A16. The first argument is the name of a graphically defined formula and the second argument is a range of cells that provide the input values to the graphically defined formula. In this manner the graphically defined formula used in the spreadsheet may be selected by providing the name of the graphically defined formula as the value of the first argument of the Xemplex function. The Xemplex function operates as a component of an add-in that provides the same sort of interfacing to a run time engine described above. The difference is that the Xemplex function provides a portal to the run time engine where the graphically defined function used by the engine to receive the input and produce to result may be selected, rather than being predefined as was the case with the TestXemplex function.

In a preferred form of the invention, a graphical representation of the graphically defined formula may be displayed as indicated by 22. In this case, the result of the function would be displayed in cell A17, but a label for that cell is not provided. Instead of entering a text label in another cell the graphic 22 serves as the label for the cell and indicates what type of data the cell contains. In addition, it also indicates which cells are used to provide that data. Accordingly, the graphic 22 provides a simple mechanism of showing that a graphically defined formula has been used to manipulate the values in cells A2 to A16 to produce the result in cell A17.

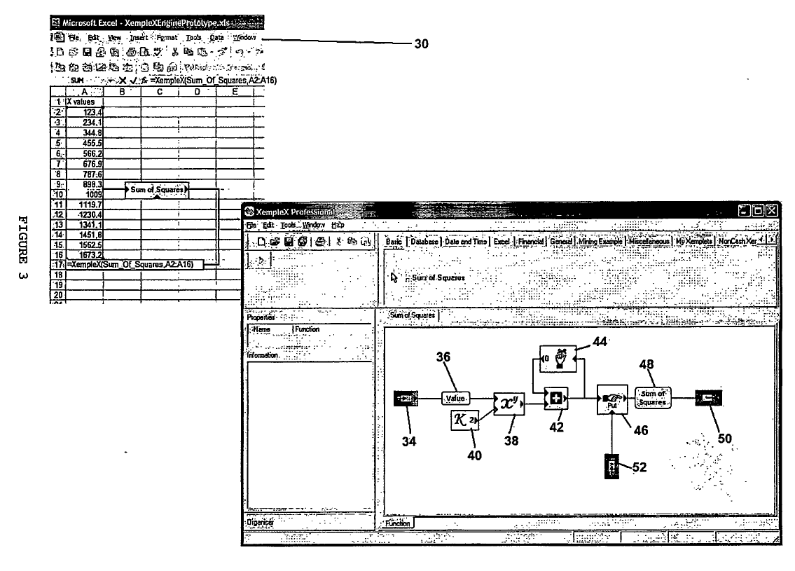

Referring to FIG. 3, a further screen shot 30 of the same spreadsheet in FIG. 2 is shown with the addition of an overlayed window 32 that shows a tool for graphically defining a formula. The add-in may allow the user to view the contents of the graphically defined formula, for example, by using the tool displayed in window 32. Alternatively, the user may be able to modify an existing graphically defined formula using the tool. Furthermore, the tool may be used to create a graphically defined formula on-the-fly for use in the spreadsheet. Once the formula is created it can then be displayed as the graphic 22.

In the example in FIG. 3, the input value from each of the cells is provided to input 34. The input is given a label 36 primarily to assist in understanding the graphically defined formula. In this case, the label 36 is “Value”. Each value provided to the input is passed to a component 38 that performs manipulation on data provided to its inputs. The other input received by the component 38 is a constant 40, in this case the constant is the numeral 2. The component 38 is a power function that raises its first input to the power of its second input. Since the second input is a constant, 2, the component 38 operates as a squaring function. The output of the component 38 is provided to one of the inputs of an addition component 42. The output of the addition component 42 is provided to a memory component 44. The output in the memory component 44 is provided to the other input of the addition component 42. This has the effect of accumulating results from the power function 38. The output of the addition component 42 is also provided to a gate component 46 that passes its input to its output only when it receives a time value from the input labelled “gt” 52. The output from the gate component 46 is labelled at 48 with “sum-of-squares” which gives a name to the connection between the gate 46 and output 50. This again assists in understanding the operation of the formula. Output 50 provides the result of the function back to the cell A17 in the spreadsheet.

During each re-calculation of the spreadsheet, which may be automatic or manual, the run time engine evaluates the graphically defined formula according to the inputs provided to input 34 and provides output 50 back to the spreadsheet to indicate the result in the cell in which the Xemplex function resides.

The add-in provides a wrapper that enables access to a dynamic link library for access to the run time engine and/or graphical formula definition tool. The add-in is accessed by using an array formula: {=Xemplex (graphically_defined_formula_name, parameter 1, parameter 2, . . . , parameter n)}.

This can allow access to any graphically defined function from within the spreadsheet program. It also allows a user to create reusable functions as the graphically defined function can be saved and reused again in the same spreadsheet or in another spreadsheet.

The add-in can provide a tool bar within the spreadsheet to launch the graphical formula definition tool from within the spreadsheet to enable creation or editing of graphically defined formulae. In addition, a run engine button 16 (in FIG. 1) can be used to provide a manual re-calculation of the formula. Preferably the graphically defined formula may be embedded inside the data file for the spreadsheet. For example, if the graphically defined formula is an XML file it can be included in the Excel spreadsheet file. Upon loading the Excel spreadsheet file, automatic re-calculation of the graphically defined formula can be conducted. The user may be provided with the ability to remove a reference or refresh a reference. Upon refreshing the reference the spreadsheet is re-calculated.

The reference to the graphically defined formula will indicate the location of the definition of the graphically defined formula. This may be within the spreadsheet data file or in a separate file. The referenced model/formula may be locked in a read only mode so that it cannot be modified. If a model is modified the modification to the definition of the graphically defined formula is saved to the specified save location.

Adding a graphically defined formula may be conducted by browsing the file system for the desired file name of the graphically defined formula. Alternatively, if the graphically defined formula are published then the user may browse for one or more published models.

A number of registered models may be provided within the Excel add-in, such as standard (frequently used) functions. In this case, a standard reference function will be accessed as described above in relation to FIG. 1.

One embodiment of the present invention provides the advantage of enabling a formula being defined in a spreadsheet program to be graphically defined and used within the spreadsheet program. Another embodiment of the present invention provides the benefit of being able to use an externally defined, graphically defined formula in a spreadsheet program.

Modifications and variations may be made to the present invention without departing from the basic inventive concept.

Such modifications may include using any spreadsheet computer program, other than Microsoft Excel. The interface between the spreadsheet and the graphical formula definition tool or graphical formula run engine may be coded into the spreadsheet, rather than being provided in an add-in. It is considered within the scope of the present invention that the functionality of a spreadsheet and of a graphical formula definition tool merge.

Such modifications and variations are intended to fall within the scope of the present invention, the nature of which is to be determined from the foregoing description.

1. A method of using a graphically defined formula within a spreadsheet computer program, comprising:
providing a spreadsheet computer program that implements a spreadsheet;
providing an engine configured to evaluate a graphically defined formula; and
interfacing the spreadsheet computer program to the engine, wherein the interfacing comprises:
(i) passing input data from the spreadsheet to the engine to produce a result by evaluating the graphically defined formula using the input data; and
(ii) passing the result from the engine to the spreadsheet computer program for entry into the spreadsheet.

2. A method according to claim 1, wherein interfacing the engine to the spreadsheet computer program is conducted by providing an interface function in a cell of the spreadsheet, with arguments of the function comprising cells in the spreadsheet containing the input data to be passed to the engine, and the result from the engine being provided in the cell in which the interface function is provided.

3. A method according to claim 2, wherein the interface function comprises a reference to the graphically defined formula as another argument to the function.

4. A method according to claim 2, wherein the interface function is in the form of a component of an add-in to the spreadsheet computer program.

5. A method according to claim 1, wherein the graphically defined formula can be selected from one or more provided graphically defined formulae.

6. A method according to claim 1, wherein the graphically defined formula may be an existing graphically defined formula that is altered using a computer implemented tool for graphically defining a formula.

7. A method according to claim 6, wherein the graphically defined formula is defined by interfacing the spreadsheet program to the tool for graphically defining the formula, using the tool to graphically define the formula, saving a definition of the graphically defined formula and passing a reference to the graphically defined formula to the spreadsheet computer program.

8. A method according to claim 1, wherein the graphically defined formula is graphically displayed.

9. A method according to claim 6, wherein the graphically defined formula is displayed by the tool for graphically defining the formula.

10. A method according to claim 8, wherein the graphically defined formula is displayed on the spreadsheet.

11. A method of graphically defining a formula for use within a spreadsheet computer program, comprising:
providing a spreadsheet computer program that implements a spreadsheet;
providing a computer implemented tool configured to graphically define a formula;
graphically defining a formula using the tool; and
placing a reference to the graphically defined formula in the spreadsheet, where the reference is used to interface the spreadsheet computer program to an engine configured to evaluate the graphically defined formula.

12. A method according to claim 11, wherein the engine evaluates the graphically defined formula by:
(i) passing input data from the spreadsheet to the engine to produce a result by evaluating the graphically defined formula using the input data; and
(ii) passing the result from the engine to the spreadsheet computer program for entry into the spreadsheet.

13. A method according to claim 12, wherein the tool is activated by the spreadsheet computer program calling the tool.

14. A method according to claim 11, wherein the reference to the graphically defined formula is placed in one or more cells in which the result(s) of evaluation of the graphically defined formula are to be displayed.

15. A method according to claim 14, wherein input data to the graphically defined formula is selected by placing a reference to cells containing the input data in the cell(s) containing the reference to the graphically defined formula.

16. A method according to claim 15, wherein the reference to the graphically defined formula and the reference to the input data cells form arguments to an interface function placed in the spreadsheet.

17. A method according to claim 16, wherein the interface function is in the form of a component of an add-in to the spreadsheet computer program.

18. A method according to claim 17, wherein the add-in comprises a calling routine for calling the tool.

19. A method according to claim 16, wherein the interface function is placed in a cell of the spreadsheet, wherein the result from the engine is provided in the cell in which the interface function is provided.

20. A method according to claim 16, wherein the reference to the graphically defined formula is an argument to the interface function.

21. A method according to claim 11, wherein the graphically defined formula may be an existing graphically defined formula that is altered using the tool for graphically defining a formula.

22. A method according to claim 11, wherein a definition of the graphically defined formula is saved for later use.

23. A method according to claim 11, wherein the graphically defined formula is graphically displayed.

24. A method according to claim 11, wherein the graphically defined formula is displayed by the tool for graphically defining the formula.

25. A method according to claim 18, wherein the graphically defined formula is displayed on the spreadsheet.

26. A computer readable medium for controlling a computer to use a graphically defined formula within a spreadsheet implemented by a spreadsheet computer program, the medium comprising
instructions configured to operate the computer as an engine that evaluates a graphically defined formula;
instructions configured to operate the computer as an interface between the spreadsheet computer program and the engine such that:
input data from the spreadsheet is passed to the engine to produce a result by evaluating a graphically defined formula using the input data; and
the result from the engine is passed to the spreadsheet computer program for display in the spreadsheet.

27. A computer readable medium for controlling a computer to graphically define a formula for use within a spreadsheet computer program, the medium comprising:
instructions configured to operate the computer as a tool that graphically defines a formula;
instructions configured to place a reference to a graphically defined formula created using the tool in the spreadsheet, wherein the reference is used to interface the spreadsheet program to an engine for evaluating the graphically defined formula.

28. A system for using a graphically defined formula within a spreadsheet, comprising:
spreadsheet means for providing a spreadsheet;
an engine configured to evaluate a graphically defined formula; and
an interface configured to:
(i) pass input data from the spreadsheet to the engine to produce a result by evaluating the graphically defined formula using the input data; and
(ii) pass the result from the engine to the spreadsheet means for entry into the spreadsheet.

29. A system for graphically defining a formula for use within a spreadsheet, comprising:
spreadsheet means for providing a spreadsheet;
a tool configured to graphically define a formula; and
a reference indicator configured to place a reference to the graphically defined formula in the spreadsheet, wherein the reference is used to interface the spreadsheet means to an engine configured to evaluate the graphically defined formula.

30. A system for using a spreadsheet computer program that implements a spreadsheet, comprising:
an interface between the spreadsheet computer program and an engine configured to evaluate a graphically defined formula, wherein the interface passes input data to the engine for the engine to produce a result based on input data, and wherein the interface passes the result from the engine to the spreadsheet computer program for insertion into the spreadsheet.

31. An system for using a spreadsheet computer program that implements a spreadsheet, comprising:
an interface between the spreadsheet computer program and a tool configured to graphically define a formula, wherein the interface activates the tool to graphically define the formula, and wherein the interface places a reference to the graphically defined formula into the spreadsheet.

32. The system according to claim 31, wherein the interface passes the reference to the graphically defined formula to an engine configured to evaluate the graphically defined formula to identify the graphically defined formula to be evaluated.

33. A system for using a graphically defined formula within an electronic spreadsheet, comprising:
means for using an electronic spreadsheet;
means for evaluating a graphically defined formula; and
means for interfacing the spreadsheet using means to the evaluating means, wherein the interfacing means comprises:
means for passing input data from the spreadsheet using means to the evaluating means to produce a result by evaluating the graphically defined formula using the input data; and
means for passing the result from the evaluating means to the spreadsheet using means for entry into the spreadsheet.
